(19) United States
(12) Patent Application Publication
(10) Pub. No.: US 2026/0160648 A1
(43) Pub. Date: Jun. 11, 2026

(54) Thermal Fluid Sampling Device

(71) Applicant: GLOBAL HOLDINGS MIDLANDS LIMITED, Stone Staffordshire (GB)

(72) Inventor: Clive JONES, Brocton Staffordshire (GB)

(73) Assignee: GLOBAL HOLDINGS MIDLANDS LIMITED, Stone Staffordshire (GB)

(21) Appl. No.: 18/707,292

(22) PCT Filed: Nov. 2, 2022
(86) PCT No.: PCT/GB2022/052759

§ 371 Date: May 3, 2024

(30) Foreign Application Priority Data
Nov. 5, 2021 (GB) 2115927.2

(51) Int. Cl. G01N 1/20; G01N 1/10

(52) U.S. Cl. CPC G01N 1/2035; G01N 2001/1031; G01N 2001/205

(57) ABSTRACT

Provided is an improved device for obtaining a sample of thermal fluid from a thermal fluid system. The device includes a thermal fluid collector vessel which is sealable, a fluid inlet which is operable to receive thermal fluid from a thermal fluid system and to transfer the thermal fluid to the thermal fluid collector vessel, a fluid outlet for removing a portion of the received thermal fluid from the collector vessel and a bleed valve. A sample of thermal fluid is selectively retained in the thermal fluid collector vessel by operation of the fluid inlet and the fluid outlet such that the sample of thermal fluid is sealed in the collector vessel to retain the integrity of the sample.

### CROSS REFERENCE TO RELATED APPLICATIONS

This application is the U.S. National Phase application of PCT International Application No. PCT/GB2022/052759, filed Nov. 2, 2022, which claims priority to United Kingdom Patent Application GB 2115927.2, filed Nov. 5, 2021, the contents of such applications being incorporated by reference herein.

### FIELD OF INVENTION

The present invention relates to a device for sampling fluid and in particular a device for sampling a thermal fluid or heat transfer fluid as used in a thermal fluid system.

### BACKGROUND OF THE INVENTION

A thermal fluid or heat transfer fluid is a liquid such as a thermal oil or gas, specifically manufactured for the purpose of transmitting heat from one system to another. It may be used to prevent overheating, for heating, or for storing thermal energy. A variety of industrial manufacturing applications require heat transfer.

Heating and cooling products in a food and beverage processing plant often requires the use of a heat exchanger. Heat exchangers may contain heat transfer fluids that absorb excess heat energy and take it away from the product, or transfer heat energy to the product. Applications of heat exchangers in food and beverage processing include brewing of beer, vegetable oil deodorising, food additive manufacturing, food packaging production and food preparation including baking, frying and cooking.

Pharmaceutical processing also requires the use of food grade heat transfer fluids in case of incidental contact with the product. Food grade heat transfer fluids are colourless, odourless, non-hazardous, non-toxic and have NSF HT1 food standard accreditation.

Chemical engineers use heat transfer for indirect heating of process liquids and polymers, single fluid batch processing, pipeline tracing, energy recovery, low pressure cogeneration, drying and heating of bulk materials and gas processing. These chemical reactions often occur at high temperatures, which must be maintained for prolonged periods.

Engineers working in plastic, polymer and styrene manufacturing plants will use heat transfer systems for a range of applications such as moulding, extrusion, press heating, line tracing, coating rolls and vulcanising. These applications require heat transfer fluid with a broad temperature range to ensure maximum efficiency and effective heat transfer. Heat transfer fluid are used in other sectors including solar power, industrial laundries, asphalt plants and engineered wood applications.

All heat transfer fluids degrade over time. In the case of thermal oils, for every 10° C. increase in temperature over its recommended upper operating temperature limit, the lifespan of a heat transfer fluid may decrease by half.

Heat transfer fluids can degrade by oxidation when the fluid reacts with oxygen in the air by a free radical mechanism. The rate of oxidation increases with temperature and the reaction causes carbon to form. Thermal degradation or thermal cracking may occur if a thermal fluid is heated above the maximum film temperature specified by the manufacturer. This leads to vaporisation and the formation of carbon. Vaporisation results in increased viscosity of the fluid, which means more energy is required to pump it around the system and this leads to increased costs for businesses.

When the concentration of carbon reaches a certain level, it starts to deposit in a sludge on the insides of the pipework, in a process known as fouling. The sludge accumulates, particularly in low flow areas such as reservoirs and expansion tanks and reduces the efficiency of heat exchange. This also increases costs for businesses.

These contaminants can reduce thermal efficiency of the system, reduce the life of the thermal fluid and lead to the formation of hot spots on heater coils. These hot spots can result in coil failure and fire. Circulating debris in any system, at any stage of its lifecycle is concerning as it can erode the pipework, accelerate the oxidation of the fluid and decrease the thermal efficiency of the heat transfer fluid. Debris will also act like a grinding paste on pump seals and impellers that will eventually lead to leaks.

Manufacturers who use heat transfer fluid in their process applications are always looking to improve a range of critical factors which affect business performance including, system availability, maintenance and management costs, operational costs and regulatory compliance. When a manufacturing process application “goes down”, production slows, product quality can be negatively affected, or production stops altogether. Despite a slow-down or shutdown in production, the business still must meet its financial obligations including; staff, rent, rates and utilities. Therefore, every hour where production is not at its optimum negatively affects a business's financial operating model.

Health and safety legislation requires that employers provide a safe working environment. DSEAR (Dangerous Substances and Explosive Atmospheres Regulations) also known as ATEX/CAD in Europe, sets out a mechanism for minimising the risks where flammable materials are handled which could create an explosive atmosphere.

Heat transfer fluids experience falling flash points over-time due to the effects of high temperature. The risk increases when heat transfer fluid has degenerated, and flash points, boiling points and auto ignition temperatures have reduced—the lower the flash points, the higher the risk. This increases fire risk in the event of loss of containment and therefore, heat transfer fluid is considered a dangerous substance under DSEAR regulations. The regulations apply to all closed heat transfer systems using heat transfer fluids and oils as a method of transferring heat.

DSEAR sets minimum requirements for protection of workers from fire (& explosion) risks related to dangerous substances & potentially explosive atmospheres. DSEAR complements the requirements to manage risks under the Management of Health & Safety at Work Regulations 1999.

Employers have a legal obligation not only to comply with DSEAR but to prepare and maintain documentary evidence. Thermocare 24/7 predictive heat transfer fluid condition monitoring and management system collects, presents and stores historical data relating to preventative condition management of the heat transfer fluid.

When a fluid needs to be replaced, engineers must drain, flush and clean the system. This will ensure that the new fluid works efficiently as soon as it enters the system, maximising the fluid life and system performance.

One key issue is determining if and when fluid needs to be replaced. It is known to test heat transfer fluid in a heat transfer system by sampling the fluid and sending it for analysis. These tests include a test for high TAN (total acid number)/ acidity (oxidation), carbon residue, levels of internal system fouling, viscosity and particulate quantity. In addition, on-site engineers may note that the heat transfer fluid cannot maintain the required operating temperature of the process if they are frequently turning up the temperature, but the flow rates have dropped off.

The current approach is to manually take thermal fluid samples on an ad-hoc basis at predetermined time intervals. However, the accuracy and safety of obtaining samples manually makes the process potentially dangerous and the results provided by the sample, inaccurate.

### SUMMARY OF THE INVENTION

An aspect of the present invention is an improved device for obtaining a sample of thermal fluid from a thermal fluid system.

Another aspect of the invention is to obtain a sample of thermal fluid from a thermal fluid system which provides an accurate representation of the condition of the thermal fluid.

Another aspect of the invention is to obtain a sample of thermal fluid from a thermal fluid system in a manner which improves the safety of the fluid sampling process.

In accordance with a first aspect of the invention there is provided, a device for sampling a thermal fluid, the device comprising:
a thermal fluid collector vessel which is sealable;
a fluid inlet which is operable to receive thermal fluid from a thermal fluid system and to transfer the thermal fluid to the thermal fluid collector vessel;
a fluid outlet for removing a portion of the received thermal fluid from the collector vessel; and a bleed valve,
wherein, a sample of thermal fluid is selectively retained in the thermal fluid collector vessel by operation of the fluid inlet and the fluid outlet such that the sample of thermal fluid is sealed in the collector vessel to retain the integrity of the sample.

Preferably, the fluid inlet is a coupling which is connectable to the thermal fluid system.

Preferably, the fluid inlet is positioned at a first end of the collector vessel.

Preferably, the coupling is a passive component, the flow of thermal fluid into the device being controlled by a valve on the thermal fluid system.

Preferably, the coupling is a Hansen coupling.

Alternatively, the fluid inlet comprises a valve.

Preferably, the fluid outlet is positioned at a second end of the collector vessel.

Preferably, the fluid outlet comprises a cap which is removeably secured to an opening in the collector vessel.

Optionally, the cap has a screw thread which is connectable to a corresponding thread on the collector vessel.

Optionally, the cap comprises the second end of the collector vessel

Advantageously, the opening covered by the cap has similar diameter to the collection vessel, thereby allowing rapid removal of thermal fluid from the collection vessel.

Optionally, the fluid outlet comprises a valve.

Preferably, the bleed valve is located at or near the first end of the collector vessel.

Preferably, the bleed valve further comprises a conduit which directs fluid from the bleed valve towards the second end of the collector vessel.

Preferably, the device further comprises a cover which shields the conduit to assist with directing the fluid from the bleed valve towards the second end of the collector vessel.

Preferably, the bleed valve has a conduit that extends from the surface at the first end of the collector vessel, a predetermined distance down its length towards the second end inside the collector vessel.

Optionally, the bleed valve conduit may be lengthened or shortened depending upon the extent to which the collector vessel is to be filled.

Preferably, the device further comprises a handle.

Preferably the handle extends longitudinally from a position at or near the first end of the collector vessel to a position at or near the second end of the collector vessel.

Preferably, the handle is thermally insulated from the collector vessel.

### BRIEF DESCRIPTION OF THE DRAWINGS

Embodiments of the present invention will now be described, by way of example only, with reference to the drawings, in which:

FIG. 1 is a perspective view from a first side of a first embodiment of a device in accordance with the present invention;

FIG. 2 is a perspective view from a second side of the first embodiment of a device in accordance with the present invention;

FIG. 3 is a perspective view of the body of the device shown in FIGS. 1 and 2;

FIG. 4 is a plan view from a first end of the body of the device shown in FIG. 3

FIG. 5 is a plan view from a second end of the body of the device shown in FIG. 3

FIG. 6 is a perspective view of an end cap which forms part of the body of the device of FIGS. 1 to 5;

FIG. 7 is a cross sectional view of the end cap of FIG. 6 attached to the second end of the body of FIGS. 1 to 5; and

FIG. 8 is a schematic view of a second embodiment of the present invention.

### DETAILED DESCRIPTION OF EXEMPLARY EMBODIMENTS

An aspect of the present invention enables a hot, closed circulating thermal fluid sample to be drawn easily and safely from a hot oil thermal fluid production process facility. The hot thermal oil sample is drawn in preparation for analysis in a laboratory which determines the oil condition for both performance and safety purposes. The results of the analysis also inform any potential need for intervention to improve oil condition for performance and safety purposes

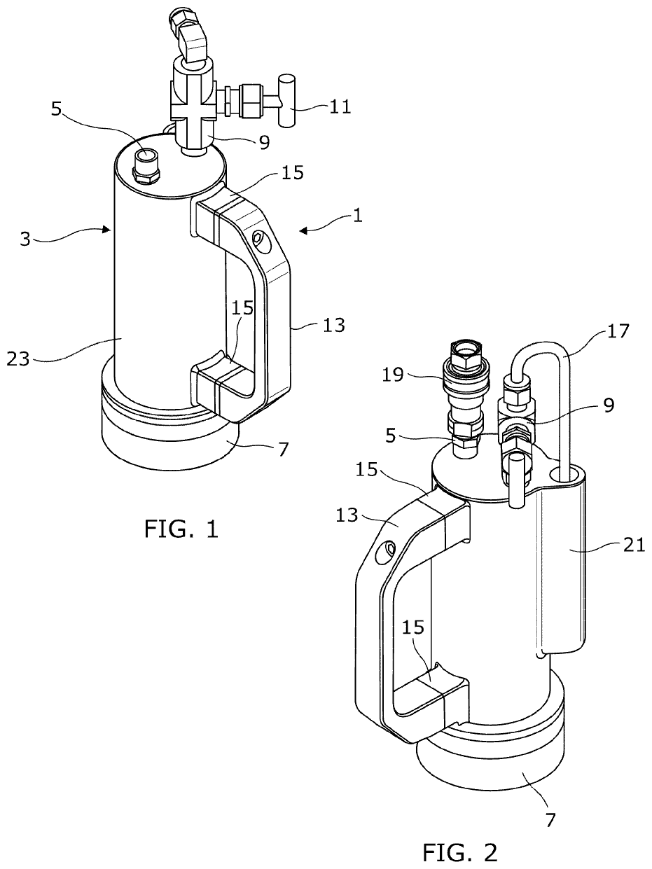

FIGS. 1 to 7 show a first embodiment of the present invention. These figures show a sampling device 1 which comprises a fluid collector vessel 3. The first or top surface of the collector vessel comprises a fluid inlet 5 and a bleed valve 9. The bleed valve has a tap 11.

The second or lower surface of the collector vessel 3 comprises an end cap 7. Handle 13 extends and is supported along the side of the fluid collector vessel 3 and has an insulating member 15 interposed between the handle 13 and the collector vessel 3.

FIG. 2 shows substantially the same device as FIG. 1 except that it also shows a bleed valve pipe 17 which extends from the bleed valve into a covered channel 21.

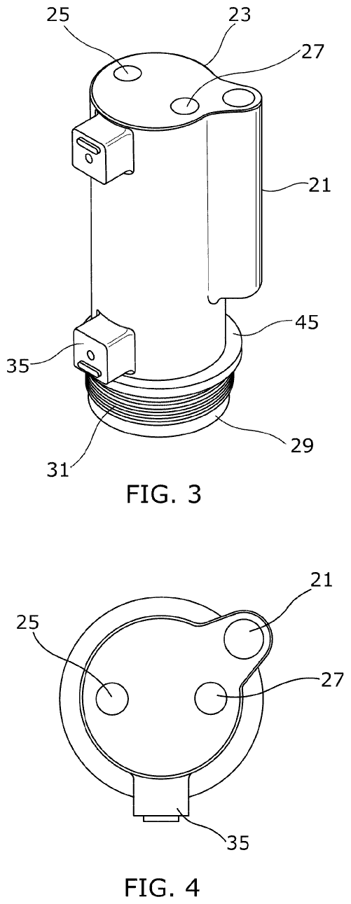

FIG. 3 shows the body 23 of the collective vessel 3. In particular it shows the inlet hole 25 to which a Hansen valve as described below, is fixed. The bleed valve hole 27 is also shown as the position where the bleed valve is connected to the body 23. The outlet end cap hole 29 is shown with a flange 45 and thread 31 to which the endcap is affixed.

FIG. 4 is a top view of the body 23 showing the inlet hole, the bleed valve hole 27 and handle stub 35, to which the insulation block 15 is attached between the body 23 and the handle 13.

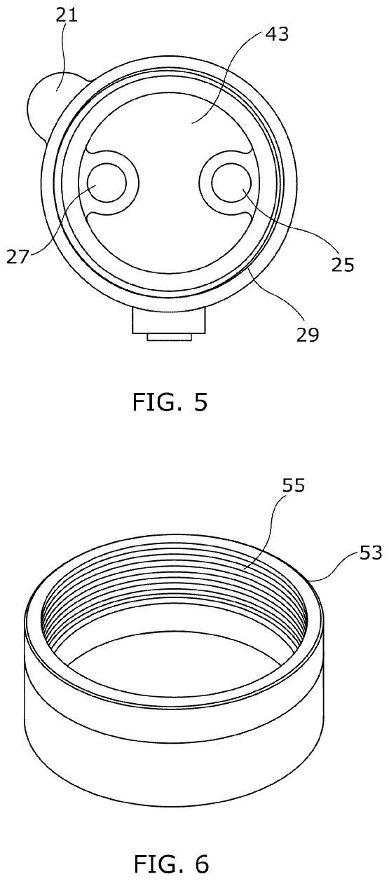

FIG. 5 is a plan view from the second or a bottom surface of the body 23 with the endcap removed. As can be seen the internal chamber 43 of the collector vessel 3 is substantially cylindrical.

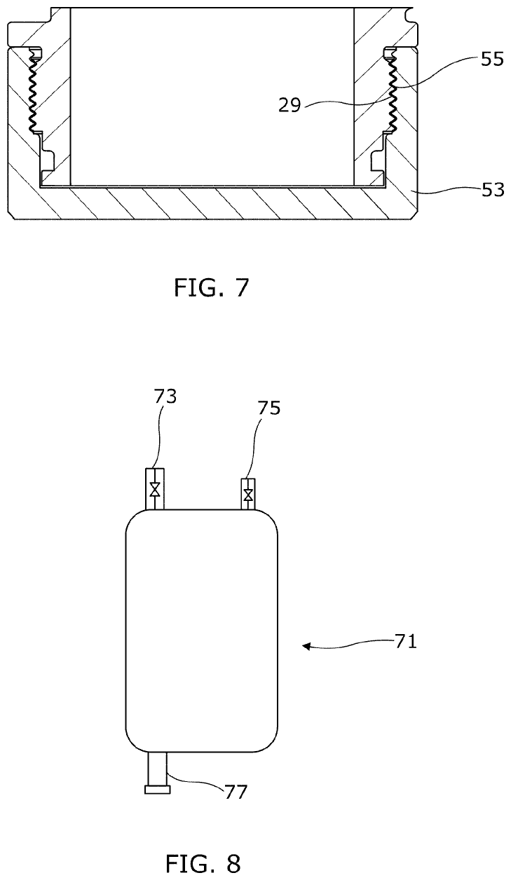

FIG. 6 and FIG. 7 relate to the endcap. FIG. 6 shows the endcap 53 and a threaded portion 55 on an internal surface. FIG. 7 shows the endcap 53 screwed onto the bottom of the body 23 of the collector vessel 3 by means of a cooperating thread on the bottom of the body.

FIG. 8 shows an alternative embodiment 71 of the present invention in schematic form in which the inlet 73 comprises a valve situated upon the collector device and the bleed valve 75 is also shown on the top surface. The outlet 77 comprises a single channel positioned on the bottom surface of the chamber and is shown with a stopper. In other embodiments of the invention, a valve may be used at the outlet.

Use of an aspect of the present invention will now be described with reference to the example provided in FIGS. 1 to 7. In use, a trained operative holds the sample collection device 1 using the handle 13 and removes the device end cap 7 by unscrewing it from the device body 23.

The thermal fluid system to which the sample collection device 1 is attached is provided with a coupling, in this example, a male fitting Hansen coupling 19 as shown in FIG. 2. The male fitting 19 may be pre-installed or added specifically for use with the sample collection device at a suitable position on a thermal oil system. The Hansen coupling 19 is a quick release coupling which connects to a female Hanson quick release coupling 5 which is fitted to the body 23 of the collection device at inlet hole 25 shown in FIG. 3.

Once the female coupling 5 on the collection device 1 is connected to the male coupling on the thermal fluid system, a waste fluid collector (not shown), for example a metal pail is positioned below the position of the fluid outlet 7, which in this example comprises an outlet hole 29, FIG. 3, covered by a cap 53. The cap 53 is unscrewed and removed from the body 23 and an isolation valve in the thermal fluid system is opened which then allows the thermal fluid to flow through the Hansen Valve and the chamber 43 of collection device 1 into the waste fluid collector. The metal pail catches the thermal fluid as it flows out of the system. In this example, about 5 litres of waste thermal fluid is collected. This thermal fluid is not used for analysis purposes but is removed from the system to “prime the fluid” and ensure the required thermal fluid sample is fresh and representative of the fluid in the system. After the waste thermal fluid has been removed, the isolation valve on the thermal fluid system is closed and the waste thermal fluid is set aside for safe disposal.

The end cap 53 of the collection device 1 is refitted and screwed hand tight. Once the end cap 53 is securely fastened, the isolation valve on the thermal system is reopened as is the bleed valve 9 on the collection device. The bleed valve 9 allows air to escape from the chamber 43 in the collection device 1 and to allow the thermal fluid to enter.

As shown in FIG. 2, the bleed valve 9 is coupled to a bleed valve pipe 17 which extends into a covered channel 21 and which directs air and hot thermal fluid from the bleed valve downwards to a waste collector vessel (not shown). The bleed valve 9 is positioned on the first (top) surface of the body 23 of the collection device 1. Once the internal chamber 43 of the collection device is full, thermal fluid will start to exit from the chamber 43 via the bleed valve 9.

In at least one other embodiment, the bleed valve has a conduit that extends from the surface at the first end of the collection vessel, a predetermined distance down its length towards the second end inside the internal chamber. The position of the entrance to the pipe in the internal chamber determines the point during the filling of the chamber at which the bleed valve will start to expel thermal fluid from the chamber, and therefore, the amount the chamber may be filled.

Whilst completely filling the chamber 43 removes substantially all of the gas from the chamber 43, In some cases, it may be desirable to avoid filling the chamber completely. The bleed valve conduit may be lengthened or shortened depending upon the extent to which the chamber is to be filled.

The waste fluid collector is repositioned underneath the covered channel 21 to catch any fluid that overflows from the bleed pocket. Once the chamber 43 is full, the isolation valve on the thermal fluid system is closed which ensures no build-up of pressure in the collection device 1 and that the system isolation valve is still holding. The isolation bleed valve 9 is closed and the Hansen valve male 19 and female 5 parts are decoupled at which point the thermal fluid sample is sealed within the collection device.

The sealed collector device 1 preserves the condition of the thermal fluid as representative of the fluid that is still contained within the thermal fluid system. The thermal fluid sample contained inside the device is not open to atmosphere which can alter the state of the thermal fluid sample and give incorrect analysis data once tested under lab conditions. Sealing the Thermal Fluid Sample Device (TFSD) properly ensures the thermal fluid sample is truly representative of the overall condition of fluid in the customers' thermal fluid system during operation.

The collection device and the thermal fluid inside it are allowed to cool to ambient temperature. This ensures that any potential volatiles (light ends—which affect the flashpoint of the fluid and in turn the fire and explosion risk of the fluid) are contained within the TFSD and the thermal fluid sample remains representative of the thermal fluid which is still inside the customer's system. The cooler (ambient temperature) thermal fluid is also safer to handle.

Once the thermal fluid is cooled to ambient temperature, the fluid is removed from the TFSD. The thermal fluid is removed from the device by turning the device upside down, unscrewing the device end cap at the base, and pouring the cooled thermal fluid into a container suitable for storing the thermal fluid while it is transport back to a laboratory.

An aspect of the present invention allows a representative of thermal fluid to be safely and reliably drawn from a customer's thermal fluid system.

Obtaining an accurate sample of the thermal fluid allows the customer to understand the condition of the thermal fluid and to support the customer in improving the thermal fluid condition. An aspect of present invention also improves the safety of the fluid extraction procedure thereby improving site safety for personnel and reducing risk for the customer's business.

When a thermal fluid sample analysis shows that the condition of the thermal fluid requires attention, the customer is advised to act in order to improve the fluid condition.

The device of an aspect of the present invention is a sealable sealed unit which avoids the need to pour a live hot sample (straight from the thermal fluid system) or a cooled thermal fluid sample (when the thermal fluid system is not hot and operating normally) straight into a bucket or other open container.

The benefit of using the device of an aspect of the present invention to draw a thermal fluid sample include, but are not limited to the following.
1. Normal production can continue while a sample is drawn.
2. The device of an aspect of the present invention draws a live, hot circulating (representative) sample to gain an accurate understanding of fluid condition.
3. The hot thermal fluid sample is drawn safely.

An accurate measurement of fluid condition and remedial engineering interventions (when required) result in a range of benefits for the customer.
1. Reduced risk for on-site personnel
2. Reduced risk to business
3. Potential for reduced insurance premiums as overall risk is better managed
4. Compliance with HSE (Health and Safety Executive) regulations and DSEAR (Dangerous Substances and Explosive Atmospheres Regulations 2002).
5. Reduced cost owing to unplanned shutdowns required to fix a system or thermal fluid contained within it
6. Helps avoid rising energy costs related to heating thermal fluid that is transferring heat inconsistently and inefficiently.
7. The ability to take a live, hot representative sample (typical 270-300 degrees C.) with significantly reduced risk to the operative.
8. Accuracy of the results to inform future maintenance and health and safety to personnel.

An aspect of the present invention ensures, as far as possible, that preventative maintenance can also be carried out while the system is running in normal production mode. Acting on heat transfer fluid condition data swiftly ensures maintenance costs are minimised and complete system shutdown is avoided whenever possible.

The cost of heating a heat transfer fluid system is significant. A manufacturer will always try to reduce the energy costs associated with the business. Keeping the heat transfer fluid in the best possible condition is essential to keep energy costs as low as possible. An aspect of the present invention ensures a production facility is operating at its optimum in order to keep operating costs as low as possible.

Improvements and modifications may be incorporated herein without deviating from the scope of the invention.

1. A device for sampling a thermal fluid, the device comprising:
a thermal fluid collector vessel which is sealable;
a fluid inlet which is operable to receive thermal fluid from a thermal fluid system and to transfer the thermal fluid to the thermal fluid collector vessel;
a fluid outlet for removing a portion of the received thermal fluid from the collector vessel; and a bleed valve,
wherein, a sample of thermal fluid is selectively retained in the thermal fluid collector vessel by operation of the fluid inlet and the fluid outlet such that the sample of thermal fluid is sealed in the collector vessel to retain the integrity of the sample.

2. The device as claimed in claim 1 wherein, the fluid inlet is a coupling which is connectable to the thermal fluid system.

3. The device as claimed in claim 1 wherein, the fluid inlet is positioned at a first end of the collector vessel.

4. The device as claimed in claim 1 wherein, the coupling is a passive component, the flow of thermal fluid into the device being controlled by a valve on the thermal fluid system.

5. The device as claimed in claim 4 wherein, the coupling is a Hansen coupling.

6. The device as claimed in claim 1 wherein, the fluid inlet comprises a valve.

7. The device as claimed in claim 1 wherein, the fluid outlet is positioned at a second end of the collector vessel.

8. The device as claimed in claim 1 wherein, the fluid outlet comprises a cap which is removeably secured to an opening in the collector vessel.

9. The device as claimed in claim 8 wherein, the cap has a screw thread which is connectable to a corresponding thread on the collector vessel.

10. The device as claimed in claim 8 wherein, the cap comprises the second end of the collector vessel and the opening covered by the cap has a similar diameter to the collection vessel, thereby allowing rapid removal of thermal fluid from the collection vessel.

11. The device as claimed in claim 1 wherein, the fluid outlet comprises a valve.

12. The device as claimed in claim 1 wherein the bleed valve located at or near the first end of the collector vessel.

13. The device as claimed in claim 1 wherein, the bleed valve further comprises a conduit which directs fluid from the bleed valve towards the second end of the collector vessel.

14. The device as claimed in claim 1 wherein, the device further comprises a cover which shields the conduit to assist with directing the fluid from the bleed valve towards the second end of the collector vessel.

15. The device as claimed in claim 1 wherein, the bleed valve has a conduit that extends from the surface at the first end of the collector vessel, a predetermined distance down its length towards the second end inside the collector vessel.

16. The device as claimed in claim 15, the bleed valve conduit may be lengthened or shortened depending upon the extent to which the collector vessel is to be filled.

17. The device as claimed in claim 1 wherein, the device further comprises a handle.

18. The device as claimed in claim 17 wherein, the handle extends longitudinally from a position at or near the first end of the collector vessel to a position at or near the second end of the collector vessel.

19. The device as claimed in claim 17 wherein, the handle is thermally insulated from the collector vessel.
